(19) United States
(12) Patent Application Publication
(10) Pub. No.: US 2010/0312895 A1
(43) Pub. Date: Dec. 9, 2010

(54) COMMUNICATION APPARATUS, COMMUNICATION METHOD THEREOF, PROGRAM AND STORAGE MEDIUM

(75) Inventor: Kenichi Fujii, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/810,821

(22) PCT Filed: Feb. 6, 2009
(86) PCT No.: PCT/JP2009/052449

§ 371 Date: Jun. 25, 2010

(30) Foreign Application Priority Data
Feb. 22, 2008 (JP) 2008-041491

(51) Int. Cl. G06F 15/16

(52) U.S. Cl. 709/226; 709/228

(57) ABSTRACT

A communication apparatus includes providing means for providing a communication parameter to another communication apparatus; managing means for managing participants in a network; and determining means for determining whether to provide a communication parameter in accordance with whether the other communication apparatus is a participant.

### TECHNICAL FIELD

The present invention relates to a communication apparatus, a communication method and program, and to a storage medium storing the program.

### BACKGROUND ART

In wireless communication typified by that performed by a wireless LAN compliant with IEEE 802.11, there are a large number of setting items that must be set before use.

Examples of setting items are communication parameters necessary in order to carry out wireless communication, such as an SSID serving as a network identifier, an encryption method, an encryption key, an authentication method and an authentication key. Setting these by manual input performed by a user is very troublesome.

Accordingly, various manufacturers have proposed automatic setting methods for setting communication parameters in wireless devices in simple fashion. According to these automatic setting methods, communication parameters are provided from one device to another device based upon a procedure and messages predetermined between the devices to be connected, and the setting of the communication parameters is performed automatically.

An example of automatic setting of communication parameters has been disclosed in Wi-Fi (certified trademark) for Wi-Fi Protected Setup: Easing the User Experience for Home and Small Office Wi-Fi (R) Networks, http://www.wi-fi.org/wp/wifi-protected-setup (referred to as a “Wi-Fi protected setup document” below).

In a case where three or more devices participate in a network, there is a method in which one device (referred to below as a “providing device”) for providing communication parameters is decided from among these participants and provides the communication parameters to the other devices (referred to as “receiving devices” below).

The specification of Japanese Patent Application Laid-Open No. 2006-352282 discloses an example of automatic setting of communication parameters among three or more devices.

With automatic setting of communication parameters described in the Wi-Fi Protected Setup document, setup processing is started by pressing a setting start button provided on a device, and automatic setup is performed between this device and another device that started setup processing in similar fashion during the setup processing.

Consider a case where automatic setting of communication parameters is carried out among three or more devices and temporary communication is being performed over the same network. This temporary network is such that the term of validity of a communication parameter lasts from connection to disconnection.

In this case, when a certain device leaves the network by entering an area in which no service is available while communication among the three devices is in progress, and then this device returns to the network, there is a possibility that the encryption key will already have changed, thereby preventing a return to the network with the communication parameter used earlier.

Since a device that has entered an area in which no service is available wishes to communicate with the other devices again, automatic setting of communication parameters is started by pressing a button.

However, this automatic setting of communication parameters requires button operation also on the side of the devices already communicating over the network. Accordingly, in order for return to the network to be accepted, a problem which arises is that automatic setting of communication parameters must be performed by temporarily suspending processing that is already in progress and performing a similar button operation.

### DISCLOSURE OF INVENTION

The present invention enables a device that wishes to be re-connected to a network to return to the network in simple fashion by having only this device perform an operation for automatic setting of communication parameters without requiring that devices remaining on the network perform this operation.

According to one aspect of the present invention, a communication apparatus includes providing means for providing a communication parameter to another communication apparatus; managing means for managing participants in a network; and determining means for determining whether to provide a communication parameter in accordance with whether the other communication apparatus is a participant.

According to another aspect of the present invention, a communication method by a communication apparatus, includes the steps of providing a communication parameter to another communication apparatus; managing participants in a network; and determining whether to provide a communication parameter in accordance with whether the other communication apparatus is a participant.

According to still another aspect of the present invention, a program for causing a communication method by a communication apparatus to be executed by computer, the program includes the steps of: providing a communication parameter to another communication apparatus; managing participants in a network; and determining whether to provide a communication parameter in accordance with whether the other communication apparatus is a participant.

Further features of the present invention will become apparent from the following description of exemplary embodiments (with reference to the attached drawings).

### BRIEF DESCRIPTION OF DRAWINGS

FIG. 1 is a block diagram illustrating the configuration of a terminal;

FIG. 2 is a block diagram of software functions within a communication parameter providing device according to a first embodiment of the present invention;

FIG. 3 is a block diagram of software functions within a communication parameter receiving device according to the first embodiment of the present invention;

FIG. 4 is a diagram illustrating configuration of a network according to the first embodiment;

FIG. 5 is a flowchart illustrating communication parameter setting processing performed by a communication parameter providing device according to the first embodiment;

FIG. 6 is a flowchart illustrating communication parameter re-setting processing performed by a communication parameter providing device according to the first embodiment; and

FIG. 7 is a flowchart illustrating communication parameter setting processing performed by a communication parameter receiving device according to the first embodiment;

FIG. 8 is a flowchart illustrating disconnection processing executed by a communication parameter providing device and receiving device according to the first embodiment;

FIG. 9 is a flowchart illustrating communication parameter setting processing performed by a communication parameter providing device according to a second embodiment of the present invention; and

FIG. 10 is a flowchart illustrating communication parameter re-setting processing performed by a communication parameter providing device according to the second embodiment.

### BEST MODE FOR CARRYING OUT THE INVENTION

### First Embodiment

A communication apparatus according to a preferred embodiment of the present invention will now be described in detail with reference to the drawings. Although the apparatus will be described with regard to an example using a wireless LAN system compliant with IEEE 802.11, the form of communication is not necessarily limited to a wireless LAN system compliant with IEEE 802.11.

The hardware configuration of the apparatus according to this embodiment will be described first.

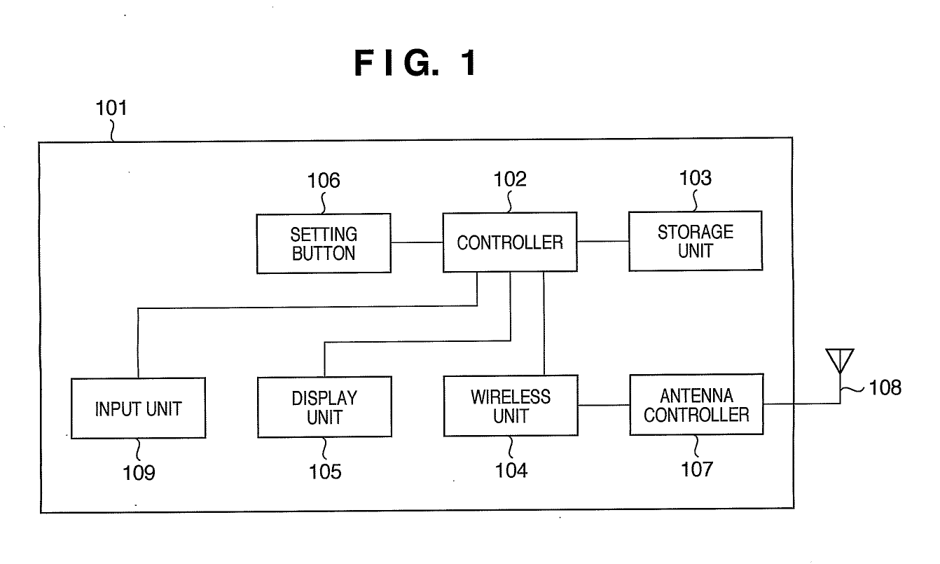

FIG. 1 is a block diagram illustrating an example of the arrangement of various units, described later. The overall apparatus, indicated at 101, includes a controller 102 for controlling the overall apparatus by executing a control program stored in a storage unit 103. The controller 102 also controls the setting of communication parameters between this apparatus and another apparatus. The storage unit 103 stores the control program executed by the controller 102 and various information such as communication parameters. Various operations, described later, are carried out by using the controller 102 to execute the control program stored in the storage unit 103. A wireless unit 104 performs wireless communication. A display unit 105 for presenting various displays has a function for outputting visually perceivable information in the manner of an LCD or LED or a function for outputting sound information in the manner of a speaker. A setting button 106 is for applying a trigger that starts the setting of a communication parameter. The button may be a physical button or a virtual button implemented by a user interface provided by software. Upon detecting operation of the setting button 106 by the user, the controller 102 starts a communication parameter setting operation, described later. An antenna controller 107 controls an antenna 108. An input unit 109 allows the user to perform various inputs.

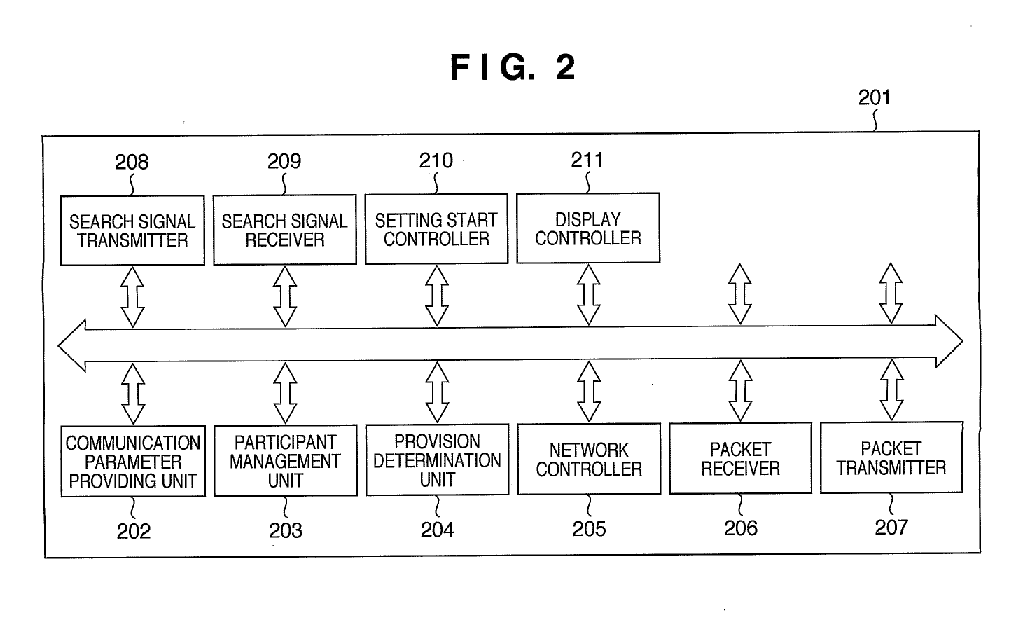

FIG. 2 is a block diagram illustrating an arrangement of software functions executed by various units, described later, in an embodiment to which the present invention can be applied. The control program for controlling these software functions has been stored in the storage unit 103. The controller 102 executes this control program, whereby the software functions are implemented.

Reference numeral 201 denotes the entirety of a parameter providing device. In communication parameter setting processing, a communication parameter providing unit 202 provides communication parameters to a receiving device. A participant management unit 203 manages provided information for carrying out identification of a member in communication parameter setting processing. A provision determination unit 204 determines whether a parameter may be provided to a receiving device. The units 202, 203 and 204 together form a function block for setting communication parameters. In this embodiment, this function block sets communication parameters necessary in order to carry out wireless communication, examples of such communication parameters being an SSID serving as a network identifier, an encryption method, an encryption key, an authentication method and an authentication key.

A network controller 205 exercises connection control when the device joins a network or generates a network, disconnection control when the devices leaves a network, and out-of-service control when the device has moved to an area where network service is no longer available. The network controller 205 also performs a power saving operation, sets the communication rate, sets the channel and acquires information indicating the strength of a receive signal.

Further, the network controller 205 controls the encryption and decryption of wireless packets encrypted by CCMP, TKIP or WEP, which are various communication encryption schemes.

A packet receiver 206 receives packets relating to a variety of communications. A packet transmitter 207 transmits packets relating to a variety of communications. A search signal transmitter 208 controls the transmission of a device search signal such as a probe request. A probe request can also be referred to as a network search signal for searching for a desired network. Transmission of the probe request, described later, is carried out by the search signal transmitter 208. Transmission of a probe response, which is a signal that is in response to the received probe request, also is carried out by the search signal transmitter 208. It should be noted that various information (self-descriptive information) of the device that transmits the device search signal is added onto the device search signal.

A search signal receiver 209 controls reception of the device search signal, such as the probe request, from another terminal. Receipt of the probe request, described later, is performed by the search signal receiver 209. Receipt of the probe response also is performed by the search signal receiver 209.

A setting start controller 210 is for controlling the start of setting processing when the setting button 106 is pressed. The setting start controller 210 receives a setting start request from a receiving device and provides communication parameters using the parameter providing device 201.

A display controller 211 displays the states of various units and presents a display for prompting user operation.

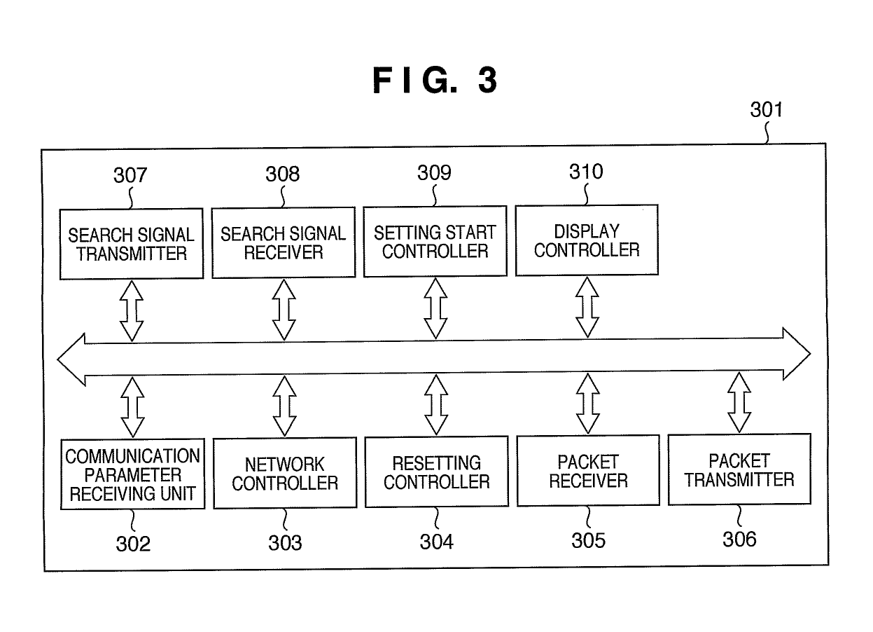

FIG. 3 is a block diagram illustrating an arrangement of software functions executed by various units, described later, in an embodiment to which the present invention can be applied. The control program for controlling these software functions has been stored in the storage unit 103. The controller 102 executes this control program, whereby the software functions are implemented.

Reference numeral 301 denotes the entirety of a parameter receiving device.

In communication parameter setting processing, a communication parameter receiving unit 302 receives communication parameters from a providing device.

A network controller 303 exercises connection control when the device joins a network or generates a network, disconnection control when the devices leaves a network, and out-of-service control when the device has moved to an area where network service is no longer available. The network controller 303 also performs a power saving operation, sets the communication rate, sets the channel and acquires information indicating the strength of a receive signal.

Further, the network controller 303 controls the encryption and decryption of wireless packets encrypted by COMP, TKIP or WEP, which are various communication encryption schemes.

A resetting controller 304 is for carrying out control of resetting of parameters, as in a case where movement to an area where network service is not available is detected in the network controller 303.

The units 302, 303 and 304 together form a function block for setting communication parameters. In this embodiment, this function block sets communication parameters necessary in order to carry out wireless communication, examples of such communication parameters being an SSID serving as a network identifier, an encryption method, an encryption key, an authentication method and an authentication key.

A packet receiver 305 receives packets relating to a variety of communications, and a packet transmitter 306 transmits packets relating to a variety of communications.

A search signal transmitter 307 controls the transmission of a device search signal such as a probe request. A probe request can also be referred to as a network search signal for searching for a desired network. Transmission of the probe request, described later, is carried out by the search signal transmitter 307. Transmission of a probe response, which is a signal that is in response to the received probe request, also is carried out by the search signal transmitter 307. It should be noted that various information (self-descriptive information) of the device that transmits the device search signal is added onto the device search signal.

A search signal receiver 308 controls reception of the device search signal, such as the probe request, from another terminal. Receipt of the probe request, described later, is performed by the search signal receiver 308. Receipt of the probe response also is performed by the search signal receiver 308.

A setting start controller 309 is for controlling the start of setting processing when the setting button 106 is pressed. The setting start controller 309 transmits a setting start request to a providing device and accepts communication parameters using the parameter receiving device 301.

A display controller 310 displays the states of various units and presents a display for prompting user operation.

It should be noted that all of the function blocks are interrelated in software or hardware function.

Further, the above-mentioned function blocks represent one example. It may be so arranged that a plurality of function blocks construct one function block, any function block may be divided into blocks that perform a plurality functions.

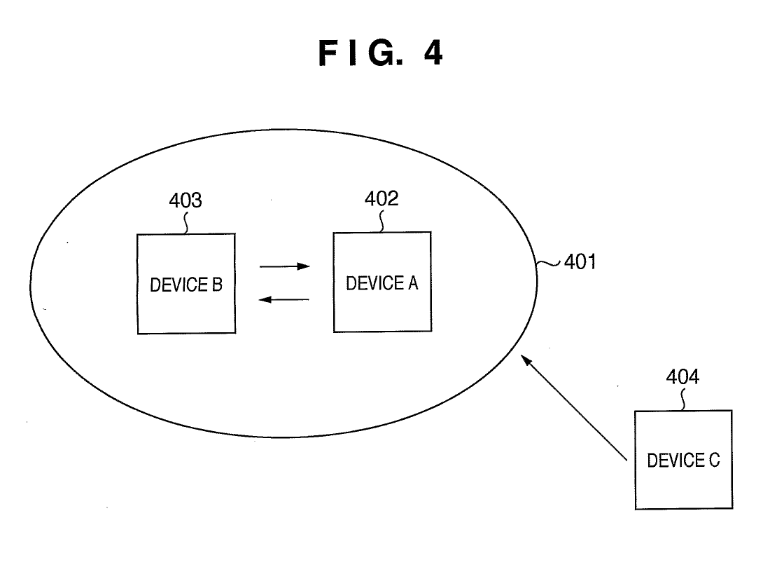

FIG. 4 is a diagram illustrating a device 402, a device 403 and a device 404, which are referred to as devices A, B and C, respectively, below. Further, a wireless LAN ad hoc network 401 generated by device A is illustrated in FIG. 4. The devices A and B are communicating with each other over the wireless LAN ad hoc network 401.

Devices A, B and C are equipped with a wireless LAN communication function compliant with IEEE 802.11 and perform wireless communication with each other by wireless LAN ad hoc (referred to simply as “ad hoc” below) communication.

Device A is a wireless parameter providing device and has the structure shown in FIGS. 1 and 2 described earlier. Devices B and C are communication parameter receiving devices and have the structure illustrated in FIGS. 1 and 3.

Parameters for performing communication over the network 401 have been stored in the storage unit 103 of device A.

After communication parameters are provided from device A to devices A and C, devices A, B and C communicated over the network 401. Consider a case where terminal C returns to the network 401 after having moved to an area where network service is not available.

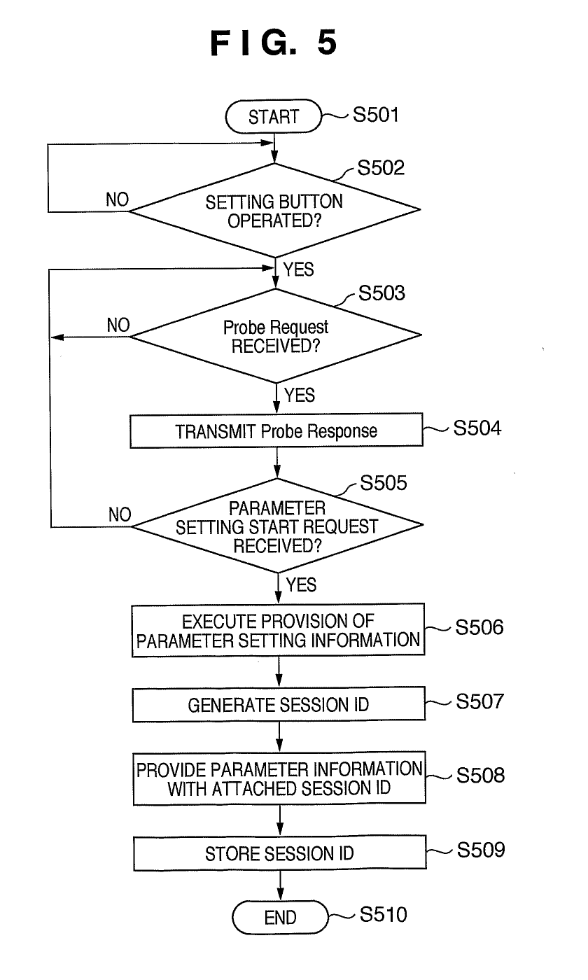

FIG. 5 is a flowchart useful in describing processing when device A, which is the providing device, executes processing for setting communication parameters.

After processing starts (S501), the setting start controller 210 checks to determine whether the setting button 106 has been operated in order to start up processing for setting communication parameters (S502). If the setting button 106 has been operated, then the search signal receiver 209 waits until receipt of a probe request is confirmed (S503). After receipt is confirmed, the search signal transmitter 208 transmits a probe response as the response (S504).

Next, the communication parameter providing unit 202 waits for receipt of a request from another party to start setting of parameters (S505). After the start request is received, the communication parameter providing unit 202 executes processing for providing communication parameters (S506).

Accordingly, before the communication parameters are provided, the participant management unit 203 generates a session ID (session identifier) correlated with these communication parameters (S507). The session ID is identification information that is valid while communication using the provided communication parameters is being carried out. For example, even if the SSID, which is a network identifier among the communication parameters, is the same, a different session ID is generated in the event that the encryption key has changed.

Next, the device A serving as the providing device provides the devices B and C, which are the receiving devices, with the communication parameter information to which the above-mentioned session ID has been attached (S508) and stores the session ID in the storage unit 103 at the same time (S509).

This completes communication parameter processing (S510).

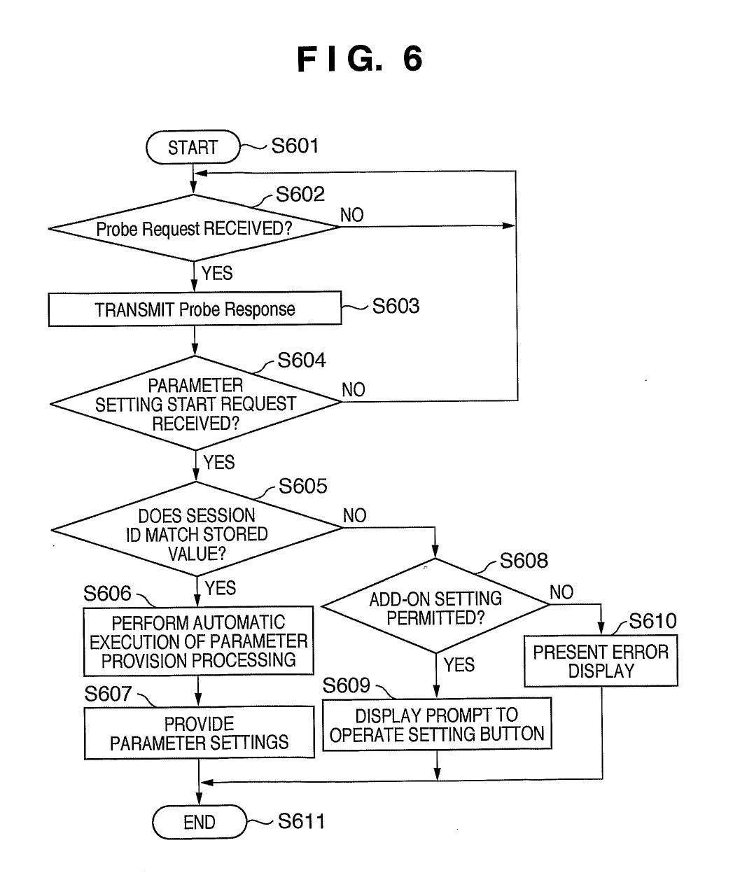

FIG. 6 is a flowchart useful in describing processing when device A, which is the providing device, executes processing for setting communication parameters without operation of the setting button 106.

Resetting control in an instance where device C returns to the network 401 from an area in which network service is not available, as in FIG. 4, is considered as a case where this processing occurs.

The reason for this is that in a case where once device C returns to the network 401 upon having entered an area in which network service is not available, whether communication is being performed on network 401 using the previous parameters or whether there has been a change in the encryption key cannot be discriminated. This makes it necessary to execute resetting processing.

First, processing is started (here it is assumed that device A is in communication with device B) (S601). The search signal receiver 209 confirms receipt of the probe request (S602). After receipt is confirmed, the search signal transmitter 208 responds by transmitting a probe response (S602).

Next, the communication parameter providing unit 202 waits for receipt of a request from another party to start setting of parameters (S604). After the start request is received, the provision determination unit 204, which determines whether parameters are to be provided or not, compares the session ID information contained in the start request message and the session ID information that has been registered in the participant management unit 203 (S605).

If the session IDs match, then the communication parameter providing unit 202 performs automatic execution of processing for setting communication parameters (S606) and provides the communication parameters of the current communication session (S607). If the session IDs do not match, first the communication parameter providing unit 202 determines whether a setting for adding on a device is permitted (S608).

In a case where device add-on is possible, the communication parameter providing unit 202 utilizes the display controller 211 to notify the user that there has been a request to add on a device anew and to prompt the operation of the setting button 106 (S609).

If add-on cannot be performed, an error display or the like is presented in similar fashion (S610). This can be utilized in a case where the user is notified of the fact that an unauthorized device has been detected.

This completes resetting control (S611).

It should be noted that the session ID may be incorporated in a message of parameter setting processing other than the parameter start request or may be incorporated in the probe request. Further, from the standpoint of security, the session ID may be processed in an encrypted format.

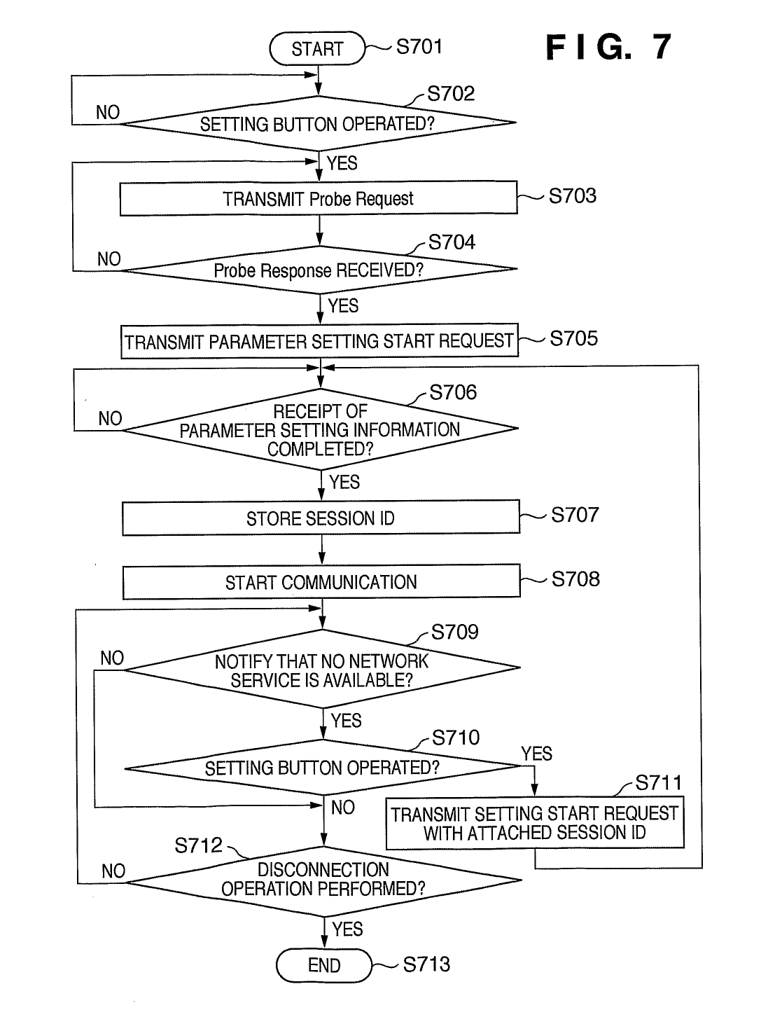

FIG. 7 is a flowchart useful in describing processing up to the point where the device C, which is the receiving device, executes processing for setting communication parameters and performs resetting control.

After the start of processing (S701), the setting start controller 309 waits for operation of the setting button 106 in order to start up processing for setting communication parameters (S702). If operation of the setting button 106 is detected, the search signal transmitter 307 transmits a probe request (S703) and the search signal receiver 308 waits for receipt of a probe response representing the response (S704).

Next, after receipt of the probe response is confirmed, the communication parameter receiving unit 302 transmits a parameter setting start request (S705) and then waits for receipt of the communication parameters to be completed (S706).

The session ID that has been attached to the communication parameters is stored in the storage unit 103 (S707) and communication is started based upon the communication parameters received (S708).

Next, using the network controller 303, the device C determines whether it is present in an area in which network service is not available (S709).

If it is detected that the device is in an area in which network service is not available, then the setting start controller 309 confirms operation of the setting button 106 (S710). If the setting operation has been performed, then the resetting controller 304 attaches the session ID, which has been stored in the storage unit 103, to the setting start request message and transmits the result (S711). Receipt of the communication parameters is performed again. This series of control operations continues to be carried out until a disconnection operation is performed (S712, S713).

The session ID may be incorporated in a message of parameter setting processing other than the parameter start request, as mentioned earlier. Further, from the standpoint of security, the session ID may be transmitted in an encrypted format.

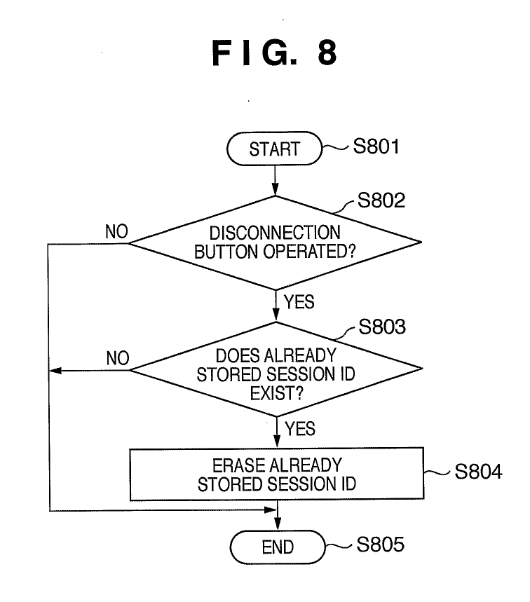

FIG. 8 is a flowchart useful in describing control when disconnection processing in devices A, B and C is executed.

The network controllers 205 and 303 wait for operation of a disconnection button (S802). If the disconnection operation has been performed, whether a session ID has been stored in the storage unit 103 is checked (S803). If the session ID has been stored, the acquired session ID is erased (S804) and processing is completed (S805).

Thus, by managing communication parameters using a session ID, a providing device need not perform a troublesome setting operation whenever a receiving device that has already been provided with communication parameters requests participation in the network; participation is made possible automatically. Further, even if an encryption key of communication parameters is changed, the session ID is changed whenever updating of communication parameters is performed. As a result, the providing device can readily determine whether the receiving device is requesting connection using communication parameters that are valid at the present time or is requesting connection using communication parameters that have already become invalid.

### Second Embodiment

It will be assumed that the example of the hardware configuration according to a second embodiment is as shown in FIG. 1, similar to the first embodiment, and that the configuration of the software blocks is as shown in FIGS. 2 and 3. Further, it will be assumed that the example of the network configuration in the second embodiment is as shown in FIG. 4, similar to the first embodiment.

Participant management is performed based upon session ID in the first embodiment. In the second embodiment, however, a case where participants are managed based upon a device-specific identifier (here a MAC address) will be considered.

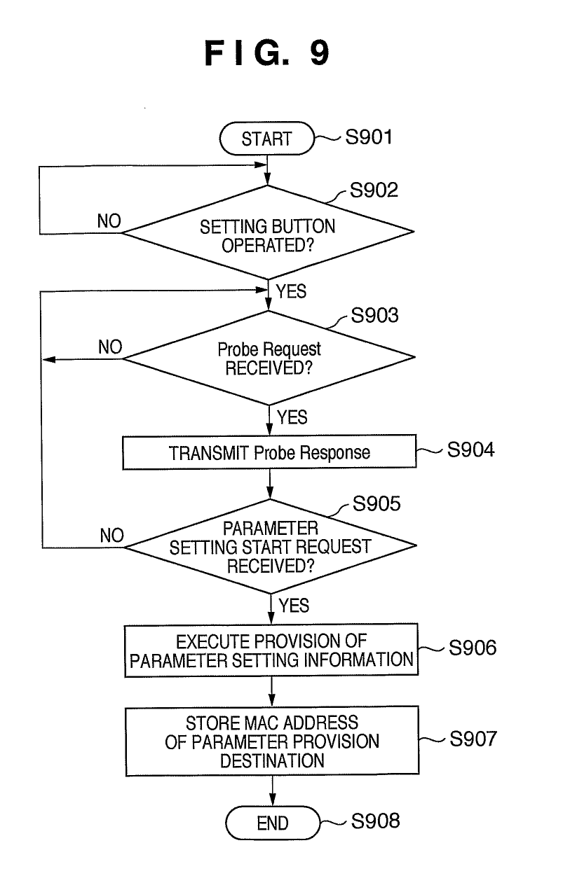

FIG. 9 is a flowchart useful in describing processing when device A, which is the providing device, executes processing for setting communication parameters.

After the start of processing (S901), the setting start controller 210 checks to determine whether the setting button 106 has been operated in order to start processing for setting communication parameters (S902). If the setting button 106 has been operated, the search signal receiver 209 waits until receipt of a probe request is confirmed (S903). After receipt of the probe response is confirmed, the search signal transmitter 208 responds by transmitting a probe response (S904).

Next, the communication parameter providing unit 202 waits for receipt of a parameter setting start request from the other party (S905). After the start request is received, the communication parameter providing unit 202 executes processing for providing communication parameters (S906).

The MAC address of the other party's device is then stored in the storage unit 103 at the same time (S907).

This completes communication parameter processing (S908).

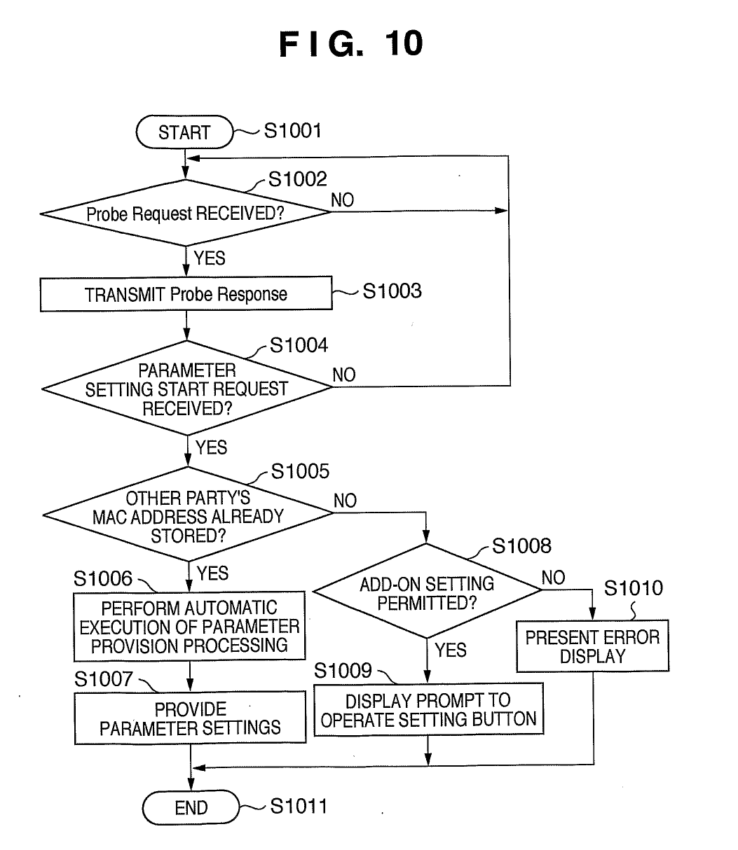

FIG. 10 is a flowchart useful in describing processing when device A, which is the providing device, executes setting of communication parameters without operation of the setting button 106.

Resetting control in an instance where device C returns to the network 401 from an area in which network service is not available, as in FIG. 4, is considered as a case where this processing occurs.

The reason for this is that in a case where once device C returns to the network 401 upon having entered an area in which network service is not available, whether communication is being performed on network 401 using the previous parameters or whether there has been a change in the encryption key cannot be discriminated. This makes it necessary to execute resetting processing.

First, processing is started (here it is assumed that device A is in communication with device B) (S1001). The search signal receiver 209 confirms receipt of the probe request (S1002). After receipt is confirmed, the search signal transmitter 208 responds by transmitting a probe response (S1003).

Next, the communication parameter providing unit 202 waits for receipt of a request from another party to start setting of parameters (S1004). After the start request is received, the provision determination unit 204, which determines whether parameters are to be provided or not, compares the MAC address of the other party's device contained in the start request message and the MAC address that has been registered in the participant management unit 203 (S1005).

If the MAC addresses match, then the communication parameter providing unit 202 performs automatic execution of processing for setting communication parameters (S1006) and provides the communication parameters of the current communication session (S1007). If the MAC addresses do not match, first the communication parameter providing unit 202 determines whether a setting for adding on a device is permitted (S1008).

In a case where device add-on is possible, the communication parameter providing unit 202 utilizes the display controller 211 to inform the user of the MAC address information and to notify the user that there has been a request to add on a device anew and prompt the operation of the setting button 106 (S1009). If add-on cannot be performed, an error display or the like is presented in similar fashion (S1010). This can be utilized in a case where the user is notified of the fact that an unauthorized device has been detected.

This completes resetting control (S1011).

Further, it goes without saying that control of the receiving device differs only in that a MAC address is appended instead of a session ID similar to the first embodiment.

Thus, by managing participants based upon a device-specific identifier such as a MAC address, the present number of already set devices can be managed and, at the same time, it is possible to individually identify a device that has requested resetting.

Although a preferred embodiment of the present invention has been described, the embodiment is an illustration for describing the invention and the illustration does not constitute gist that narrows the scope of the invention solely to this embodiment. Various modifications are possible without departing from the scope of the invention.

For example, in the description of the foregoing embodiments, a probe request and a probe response are used. However, there is no limitation upon the signals transmitted and any signals may be used so long as the play similar roles.

Further, the foregoing description has been rendered taking a wireless LAN compliant with IEEE 802.11 as an example. However, the present invention may be implemented also with other wireless media such as a wireless USB, MBOA, Bluetooth (registered trademark), UWB and ZigBee. Further, the invention may be applied also to a wired communication medium such as a wired LAN.

Here “MBOA” is the abbreviation of “Multi-Band OFDM Alliance”, and UWB includes wireless USB, wireless 1394 and WINET, etc.

Further, although a network identifier, encryption method, encryption key, authentication method and authentication key have been mentioned as wireless parameters, it goes without saying that other information may be used and that other information may be included in communication parameters.

The object of the invention is attained also by supplying a recording medium storing the program codes of the software for performing the functions of the foregoing embodiment to a system or an apparatus, reading the program codes, which have been stored on the recording medium, with a computer (e.g., a CPU or MPU) of the system or apparatus from the storage medium, and then executing the program codes. In this case, the program codes per se read from the recording medium implement the functions of the embodiment and the recording medium storing the program codes constitutes the invention.

Examples of recording media that can be used for supplying the program code are a flexible disk, hard disk, optical disk, magneto-optical disk, CD-ROM, CD-R, magnetic tape, non-volatile type memory card, ROM or DVD, etc.

Further, besides the case where the aforesaid functions according to the embodiment are implemented by executing the read program code by computer, an operating system or the like running on the computer may perform all or a part of the actual processing based upon instructions in the program code so that the foregoing functions are implemented.

Furthermore, the program code read from the storage medium is written to a memory provided on a function expansion board inserted into the computer or provided in a function expansion unit connected to the computer. A CPU or the like mounted on the function expansion board or function expansion unit performs all or a part of the actual processing based upon instructions in the program code so that the foregoing functions are implemented.

In accordance with the present invention, as described above, if a communication device that has moved into an area in which network service is not available wishes to return to the network, only the communication device that requests return is capable of being accepted without requiring that other communication devices already communicating over the network perform some operation. Accordingly, the convenience of automatic setting of communication parameters can be enhanced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-041491, filed Feb. 22, 2008, which is hereby incorporated by reference herein in its entirety.

1. A communication apparatus comprising:
a providing unit that provides a communication parameter to another communication apparatus;
a managing unit that manages participants in a network; and
a determining unit that determines whether to provide a communication parameter in accordance with whether the other communication apparatus is a participant.

2. The apparatus according to claim 1, wherein said managing unit manages participants by a network-specific identifier generated based upon the communication parameter.

3. The apparatus according to claim 1, wherein said managing unit manages participants by a network-participant-specific identifier generated based upon the communication parameter.

4. The apparatus according to claim 2, wherein said determining unit compares identification information contained in a signal transmitted from the other communication apparatus and the specific identifier for managing the participant and determines whether the other communication apparatus is a participant in accordance with whether there is a match.

5. The apparatus according to claim 2, wherein said determining unit starts processing for providing the communication parameter to the other communication apparatus if identification information contained in a signal transmitted from the other communication apparatus matches the specific identifier for managing the participant.

6. The apparatus according to claim 2, wherein said determining unit forgoes starting processing for providing the communication parameter to the other communication apparatus if identification information contained in a signal transmitted from the other communication apparatus does not match the specific identifier for managing the participant.

7. The apparatus according to claim 2, wherein said determining unit has a display unit that displays the fact that a request to participate in the network has been generated anew if identification information contained in a signal transmitted from the other communication apparatus does not match the specific identifier for managing the participant.

8. The apparatus according to claim 2, wherein if identification information contained in a signal transmitted from the other communication apparatus does not match the specific identifier for managing the participant, said determining unit starts said providing unit that provides the communication parameter to the other communication apparatus in a case where an operation for allowing participation has been performed.

9. The apparatus according to claim 2, wherein the specific identifier is managed by said managing unit in a period in which other participants are being identified.

10. The apparatus according to claim 2, wherein management of the specific identifier by said managing unit is terminated if an operation to leave the network has been performed or if the participant can no longer be identified.

11. The apparatus according to claim 2, wherein the specific identifier is a session identifier of the network that has been constructed, and the participant has the same session identifier.

12. The apparatus according to claim 3, wherein the specific identifier is MAC address information specific to the participant.

13. The apparatus according to claim 11, wherein the session identifier is updated to a new session identifier along with a change of an encryption key of the network that has been constructed.

14. The apparatus according to claim 13, wherein the new session identifier is provided to a participant that is allowed to communicate on the network that has been constructed.

15. A communication method by a communication apparatus, comprising the steps of:
providing a communication parameter to another communication apparatus;
managing participants in a network; and
determining whether to provide a communication parameter in accordance with whether the other communication apparatus is a participant.

16. A program for causing a communication method by a communication apparatus to be executed by computer, said program comprising the steps of:
providing a communication parameter to another communication apparatus;
managing participants in a network; and
determining whether to provide a communication parameter in accordance with whether the other communication apparatus is a participant.

17. A computer-readable storage medium on which the program set forth in claim 16 has been stored.
